(19) United States
(12) Patent Application Publication
(10) Pub. No.: US 2013/0255469 A1
(43) Pub. Date: Oct. 3, 2013

(54) Horn Performance Stand

(71) Applicant: Robert Winston Carter, (US)

(72) Inventor: Robert Winston Carter, (US)

(21) Appl. No.: 13/431,285

(22) Filed: Mar. 27, 2012

(51) Int. Cl. G10G 5/00

(52) U.S. Cl. CPC G10G 5/005
USPC 84/387 A

(57) ABSTRACT

A Horn Performance Stand has a tripod (1) on which is mounted a support block (3) on which is mounted a foam tubing cylinder (6). The foam cylinder is cut to accept and support a brass musical instrument to minimize pressure on the lips while performing.

### BACKGROUND

1. Field of the Invention

This invention relates to the support of musical instruments requiring the performer to put a mouthpiece on the lips while playing as with the trumpet and other brass types. Excess mouthpiece pressure on the lips plagues many players including the best performers.

2. Description of Prior Art

Brass or similar instruments have been played for thousands of years with most performers facing the problem of applying excess pressure to the lips while manually holding the instrument. The Horn Performance Stand was designed to aid either practice or performance while approaching zero pressure on the lips with the horn supported by the stand. Hsieh, U.S. Pat. No. 7,459,622 showed a support stand design but not for use during performance. Shumake, US 20050145094 showed a support design for use during performance by special-needs players. Invention proceeds toward all players from the background of prior art.

### SUMMARY OF THE INVENTION

### Object and Advantages

Object of patentable novelty and utility taught by this invention are to provide a Horn Performance Stand that:

Has a tripod or similar adjustable support base.

Has a solid support block mounted permanently on top of the tripod.

Has a closed-cell foam tube cut and mounted permanently on top of the tripod supported block.

Has the foam tube support but not capture the instrument so the performer can change quickly between horns of different lengths.

The invention accomplishes the objectives: a horn is not captured but is supported from the bottom and the sides allowing almost any static performer to play with nearly zero pressure from the mouthpiece on the lips. By adjusting the tripod, the performer obtains a very close approximation to normal playing posture except for mouthpiece pressure. Both hands are free to play as normal.

### BRIEF DESCRIPTION OF FIGURES

The invention is described by appended claims in relation to a preferred embodiment with reference to the following figures that are explained briefly as follows:

FIG. 1 is a side view of the Horn Performance Stand holding a trumpet in the foam cylinder mounted on a tripod.

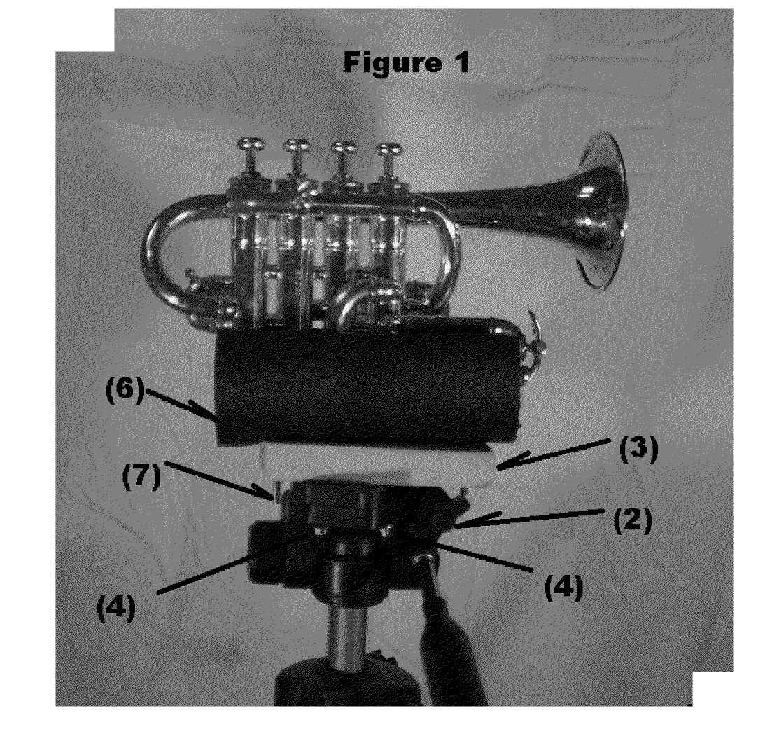

FIG. 2. Is a front or audience view of the Horn Performance Stand holding a trumpet in the foam cylinder on a tripod.

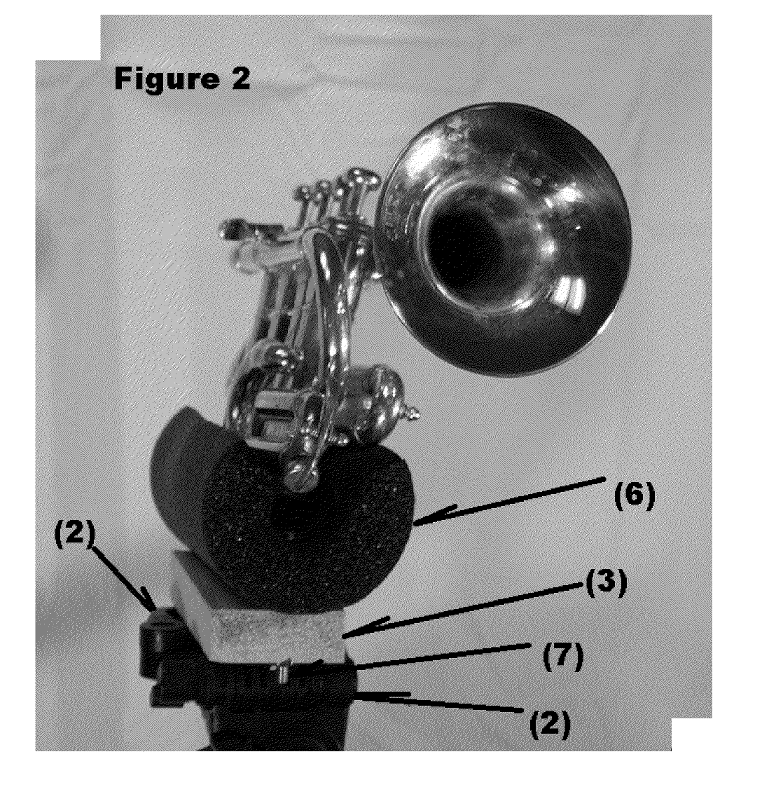

FIG. 3 is a side view of the Horn Performance Stand alone showing most of the tripod with the support block and foam cylinder.

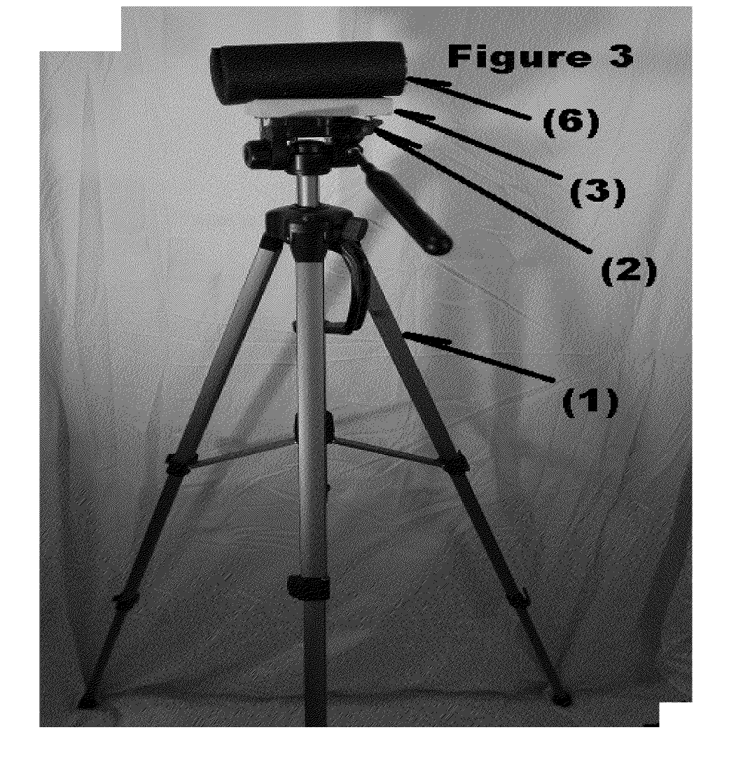

FIG. 4 is a front view of the Horn Performance Stand alone showing attachment detail of the foam cylinder to the support block.

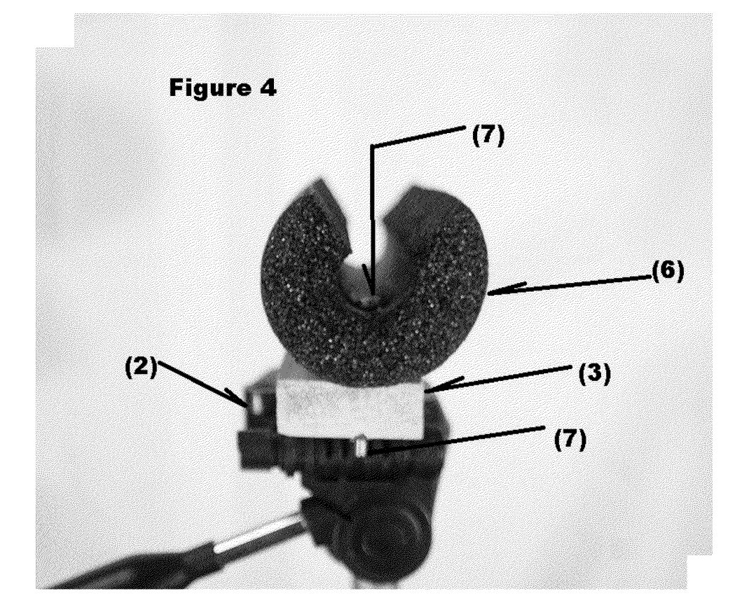

FIG. 5 is a side view of the Horn Performance Stand showing bolts for the support block attachment and foam cylinder attachment.

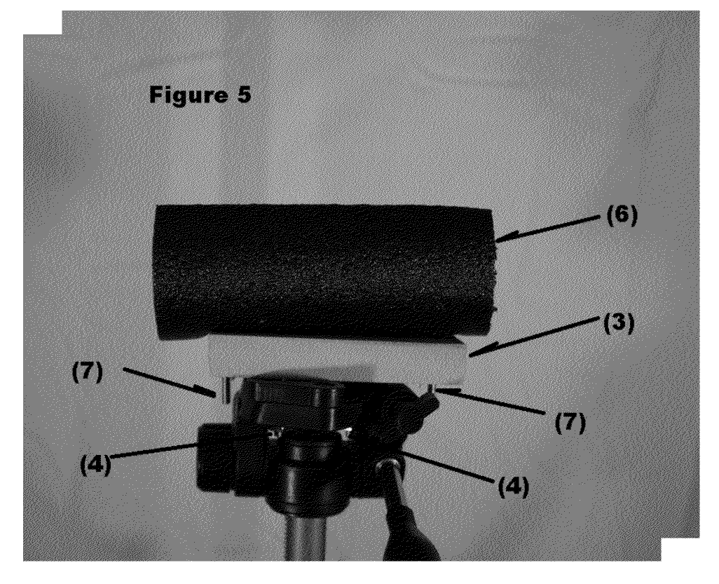

### DESCRIPTION OF PREFERRED EMBODIMENT

### Reference Numerals

Listed numerically below with reference to the figures are terms used to describe features of the invention. The terms and numbers assigned to them are used throughout this description.

1. Tripod assembly as common in photography.

2. Tripod Top Base, the top surface of (1), drilled to accept two bolts.

3. Foam Support Block, a solid block of wood or similar material, drilled to accept two bolts.

4. Foam Support Bolt, a threaded bolt holding the solid support block on the Tripod Top Base (2).

5. Foam Support Nut, a nut capturing the solid Support Block(3) on the Tripod Top Base(2).

6. Foam Cylinder, a closed-cell foam tube cut to receive a brass instrument.

7. Foam Cylinder Bolt, a threaded bolt holding the Foam Cylinder (6) on the the support block(3).

8. Foam Cylinder Nut, a nut capturing the Foam Cylinder(6) on the support block(3).

What is claimed:

1. A Horn Performance Stand comprising:
A cylinder cut lengthwise to accept a musical instrument without scratching or mechanical capture of the instrument.

2. A Horn Performance Stand of claim 1 wherein:
An accepting cylinder for a musical instrument is permanently mounted to a solid block.

3. A Horn Performance Stand of claim 2 wherein:
A solid block holding an accepting cylinder for a musical instrument is permanently mounted to a fixed or adjustable platform of which a tripod is one example.
